(19) United States
(12) Patent Application Publication
(10) Pub. No.: US 2026/0175161 A1
(43) Pub. Date: Jun. 25, 2026

(54) Flue Gas Purification and CO2 Capture Coupling System and Carbon Capture Method

(71) Applicant: HUANENG CLEAN ENERGY RESEARCH INSTITUTE, Beijing (CN)

(72) Inventors: Dongfang GUO, Beijing (CN); Weidong LI, Beijing (CN); Huanjun WANG, Beijing (CN); Jinhang FAN, Beijing (CN); Bin HUANG, Beijing (CN); Ye QIN, Beijing (CN); Shiwang GAO, Beijing (CN)

(21) Appl. No.: 19/430,751

(22) Filed: Dec. 23, 2025

(30) Foreign Application Priority Data
Dec. 25, 2024 (CN) 202411920705.5

(51) Int. Cl. B01D 53/14; B01D 53/34; B01D 53/62; B01D 53/78; B01D 53/96

(52) U.S. Cl. CPC B01D 53/1475; B01D 53/1412; B01D 53/1425; B01D 53/346; B01D 53/62; B01D 53/78; B01D 53/96; B01D 2257/504; B01D 2258/0283; B01D 2259/40003

(57) ABSTRACT

The present disclosure proposes a flue gas purification and CO₂ capture coupling system and a carbon capture method. The flue gas purification and CO₂ capture coupling system comprises a flue gas generation device, a flue gas purification device, and a CO₂ capture device. The CO₂ capture device comprises an absorption tower containing an absorbent solution and a regeneration tower. A rich absorbent solution that has absorbed CO₂ in the absorption tower flows into the regeneration tower where it is heated and desorbed into a regenerated gas and a lean solution. A portion of the lean solution discharged from the regeneration tower is used to exchange heat with high-temperature flue gas that has left the flue gas generation device but has not yet entered the CO2 capture device, thereby forming a superheated lean solution. The superheated lean solution is returned to the regeneration tower to provide steam and heat for the CO2 regeneration reaction. The superheated lean solution specifically refers to a CO2-lean solution that is maintained in a state just below boiling under a preset pressure. Therefore, the flue gas purification and CO₂ capture coupling system of the embodiments of the present disclosure has the advantages of low energy consumption and capture cost, and high operational stability and safety.

### CROSS-REFERENCE TO RELATED APPLICATION

The disclosure claims the priority to Chinese Patent Application No. CN202411920705.5, filed at the Chinese Patent Office on Dec. 25, 2024, and entitled “Flue Gas Purification and CO₂ Capture Coupling System and Carbon Capture Method”, which is incorporated herein in its entirety by reference.

### Technical Field

The present disclosure relates to the field of carbon capture, utilization, and storage (CCUS) technology, and in particular, to a flue gas purification and CO₂ capture coupling system and method.

### BACKGROUND

Carbon capture, utilization, and storage (CCUS) is an important means for large-scale low-carbon utilization of fossil energy, playing a critical role in ensuring national energy security and building a strong energy nation. High energy consumption and high cost are the main obstacles to the large-scale promotion of CCUS technology, while carbon capture cost accounts for 75% of the full-chain cost. Reducing carbon capture cost is an urgent international problem that needs to be solved for the development of CCUS technology. The capture cost mainly lies in the steam consumption during the regeneration process, that is, the heat required for CO₂ regeneration is usually provided by superheated steam extracted from the power plant generating unit. This consumes a large amount of steam, resulting in a higher carbon capture cost, with the steam cost accounting for approximately 50% of the total capture cost. In addition, extracting steam will reduce the power generation efficiency of the power plant, increase the auxiliary load loss of the power plant, and further increase the capture cost. In addition, the integration of the CO₂ capture system requires significant modifications to the existing equipment system, which in turn affects the flue gas purification and treatment process. The related art also proposes utilizing flue gas waste heat to replace the extracted superheated steam for supplying heat to the carbon capture system. However, there still exist numerous problems such as insufficient heat utilization, unreasonable temperature matching, and relatively high energy consumption within the system, which affect practical application. Therefore, there is a need for improvement.

### SUMMARY

The present disclosure aims to solve, at least to a certain extent, one of the technical problems in the related art.

To this end, the present disclosure proposes a flue gas purification and CO₂ capture coupling system. The flue gas purification and CO₂ capture coupling system has the advantage of reducing capture energy consumption.

The flue gas purification and CO₂ capture coupling system includes a flue gas generation device, a flue gas purification device, and a CO₂ capture device.

The flue gas discharged from the flue gas generation device is purified by the flue gas purification device and then enters the CO₂ capture device; after CO₂ capture and decarbonization, the flue gas is finally discharged to the outside, while simultaneously completing separation and storage of CO₂; the CO₂ capture device includes an absorption tower and a regeneration tower, a rich solution that has absorbed CO₂ in the absorption tower flows into the regeneration tower, where the rich solution is heated and desorbed into a regenerated gas and a lean solution; the regenerated gas and the lean solution are separately discharged from the regeneration tower; wherein a portion of the lean solution discharged from the regeneration tower exchanges heat with flue gas that has been discharged from the flue gas generation device but has not yet entered the CO₂ capture device, thereby forming a superheated lean solution; the superheated lean solution is returned to the regeneration tower to provide steam and heat for desorption; the superheated lean solution specifically refers to a CO₂-lean solution that is maintained in a state just below boiling under a preset pressure.

In some embodiments, the flue gas generating device includes a boiler and an air preheater, and the flue gas discharged from the boiler passes through the air preheater and then exchanges heat with the portion of the lean solution.

In some embodiments, the CO₂ capture device includes a reboiler, the flue gas generated by the flue gas generation device passes through the reboiler and exchanges heat with the portion of the lean solution, and the portion of the lean solution after heat exchange is returned to the regeneration tower to provide heat for the regeneration reaction.

In some embodiments, the CO₂ capture device further includes a lean-rich solution heat exchanger, wherein the rich solution discharged from the absorption tower passes through the lean-rich solution heat exchanger and then enters the regeneration tower, and another portion of the lean solution discharged from the regeneration tower enters the lean-rich solution heat exchanger to exchange heat with the rich solution flowing through the lean-rich solution heat exchanger and then enters the absorption tower.

In some embodiments, the flue gas purification device includes a denitration tower and a desulfurization tower; the flue gas discharged from the boiler sequentially passes through the denitration tower, the air preheater, and the desulfurization tower, and then enters the absorption tower; after CO₂ capture and decarbonization, the flue gas becomes decarbonized flue gas and is discharged from the absorption tower to the outside.

In some embodiments, the CO₂ capture device further includes a pressurizing pump; the pressurizing pump is arranged between the regeneration tower and the reboiler; the pressurizing pump is used to pressurize the portion of the lean solution to raise its boiling point

In some embodiments, the CO₂ capture device further includes a pressure-reducing valve; the pressure-reducing valve is arranged between the reboiler and the regeneration tower and close to the regeneration tower; the pressure-reducing valve is used to depressurize the superheated lean solution that has passed through the reboiler and has exchanged heat with the flue gas to lower the boiling point of the superheated lean solution; the depressurized superheated lean solution is returned to the regeneration tower and releases steam.

In some embodiments, the regeneration tower has a lean solution inlet, wherein the depressurized superheated lean solution is returned to the regeneration tower through the lean solution inlet, and the lean solution inlet is located below the packing inside the regeneration tower but above the liquid level of the lean solution pool at the bottom of the regeneration tower.

In some embodiments, the pressurizing pump pressurizes the portion of the lean solution discharged from the regeneration tower to 3-7 atmospheres.

In some embodiments, the pressure-reducing valve depressurizes the superheated lean solution discharged from the reboiler to 1.2-2.0 atmospheres.

In some embodiments, in the portion of the lean solution returned to the regeneration tower after depressurization, the vapor phase accounts for 2%-15% of the total mass of the returned lean solution.

In some embodiments, the portion of the lean solution accounts for 20%-60% of the total mass of the lean solution discharged from the regeneration tower.

In some embodiments, the CO₂ capture device further includes a rich solution preheater; the rich solution generated in the absorption tower sequentially passes through the rich solution preheater and the lean-rich solution heat exchanger and then enters the regeneration tower; the regenerated gas generated in the regeneration tower enters the rich solution preheater to exchange heat with the rich solution passing through the rich solution preheater.

In some embodiments, the CO₂ capture device further includes a flue gas reheater; the another portion of the lean solution discharged from the regeneration tower sequentially passes through the lean-rich solution heat exchanger and the flue gas reheater and then enters the absorption tower; the decarburized flue gas discharged from the absorption tower enters the flue gas reheater to exchange heat with the lean solution passing through the flue gas reheater and then is discharged to the outside.

In some embodiments, the CO₂ capture device further includes a flow control valve, and the flow control valve is used to control the ratio of the flue gas entering the flue gas reheater and the flue gas entering the absorption tower from the desulfurization tower.

In some embodiments, a flowmeter matched to the flow control valve is provided to monitor the flow rate of the flue gas entering the CO₂ capture device.

In some embodiments, the flue gas purification device further includes two flow control valves and an induced draft fan; the induced draft fan is arranged between a desulfurized flue gas outlet of the desulfurization tower and the pre-wash tower; one of the two flow control valves is arranged between the desulfurized flue gas outlet of the desulfurization tower and a flue gas inlet of the flue gas reheater so as to control the amount of desulfurized flue gas entering the flue gas reheater, and the other of the two flow control valves is arranged between the desulfurized flue gas outlet of the desulfurization tower and the induced draft fan so as to control the amount of flue gas entering the pre-wash tower from the desulfurization tower; the two flow control valves are operated in coordination.

In some embodiments, the flue gas purification device further includes a pre-wash tower, a dust collector, and a stack, and the CO₂ capture device further includes a CO₂ compressor, wherein the dust collector is arranged between the reboiler and the desulfurization tower and is used to remove dust from flue gas discharged from the reboiler, and the CO₂ compressor is connected with the rich solution preheater to compress the regenerated gas after it has exchanged heat with the rich solution in the rich solution preheater.

The flue gas purification and CO₂ capture coupling method according to embodiments of the present disclosure includes:
flue gas discharged from a flue gas generation device is purified by a flue gas purification device and then enters a CO₂ capture device; after CO₂ capture and decarburization, the flue gas is finally discharged to the outside, while completing storage of CO₂; the CO₂ capture device includes an absorption tower and a regeneration tower; a rich solution that has absorbed CO₂ in the absorption tower flows into the regeneration tower,
where it is heated and desorbed into a regenerated gas and a lean solution; the regenerated gas and lean solution are separately discharged from the regeneration tower;
a portion of the lean solution discharged from the bottom of the regeneration tower exchanges heat with flue gas that has been discharged from the flue gas generation device but has not yet entered the CO₂ capture device, thereby forming a superheated lean solution; the superheated lean solution is returned to the regeneration tower to provide steam and heat for desorption.

In dome embodiments, the glue has purification and CO₂ capture coupling method according to embodiments of the present disclosure further includes pressurizing a portion of the lean solution discharged from the regeneration tower to raise its boiling point, wherein the pressurized portion of the lean solution exchanges heat with flue gas that has been discharged from the flue gas generation device but has not yet entered the CO₂ capture device.

In some embodiments, the flue gas purification and CO2₂ capture coupling method according to embodiments of the present disclosure further includes depressurizing the superheated lean solution to lower its boiling point, wherein the depressurized superheated lean solution is returned to the regeneration tower.

In some embodiments, the depressurized superheated lean solution is returned to below the packing in the regeneration tower.

In some embodiments, the rich solution discharged from the absorption tower sequentially exchanges heat with the regenerated gas discharged from the regeneration tower and another portion of the lean solution discharged from the regeneration tower and then flows into the regeneration tower.

In some embodiments, the flue gas purification and CO₂ capture coupling method according to embodiments of the present disclosure further includes causing the flue gas discharged from the flue gas generation device to sequentially undergo denitration, air preheating, heat exchange with the portion of the lean solution discharged from the regeneration tower, dust removal, and desulfurization; a portion of the desulfurized flue gas, together with another portion of the lean solution that has been discharged from the regeneration tower and has exchanged heat with the rich solution, exchanges heat with the decarbonized flue gas discharged from the absorption tower; the another portion of the lean solution that has exchanged heat with the decarbonized flue gas flows into the absorption tower; the decarbonized flue gas that has exchanged heat with the portion of the desulfurized flue gas and the another portion of the lean solution is discharged to the outside; another portion of the desulfurized flue gas enters the absorption tower.

In some embodiments, the ratio of the portion of the desulfurized flue gas that exchanges heat with the decarbonized flue gas to the another portion of the desulfurized flue gas that enters the absorption tower is controlled.

In some embodiments, the flue gas may originate from various sources that generate high-temperature flue gas, such as power plant boilers, cement plant off-gases, steel plant off-gases, and the like.

According to the present disclosure, a portion of the lean solution discharged from the regeneration tower is used to exchange heat with high-temperature flue gas that has left the flue gas generation device but has not yet entered the CO₂ capture device, thereby forming a superheated lean solution which is then returned to the regeneration tower to supply steam and heat for the CO₂ regeneration reaction; after partial vaporization, the superheated lean solution is returned to the regeneration tower, thereby promoting desorption of CO₂ in the regeneration tower, that is, the heat required for CO₂ regeneration is provided by the high-temperature flue gas. By heating the lean solution with flue gas to generate steam that participates in the regeneration process, it is possible to partially or even completely replace the conventional steam supplied from outside the system, thereby avoiding the consumption of high-value superheated steam, effectively reducing the overall energy consumption of the system, and reducing the capture cost per tonne of CO₂ by 40%-50%.

At the same time, the use of the system according to the present disclosure is conducive to adding additional equipment when modifying existing related equipment, as it requires only the addition of pipelines, thereby significantly reducing the modification cost of the system.

In addition, the present disclosure utilizes pressurized lean solution to exchange heat with the flue gas, thereby forming a superheated lean solution. In the pressurized state, the superheated lean solution does not undergo substantial vaporization inside the reboiler, which prevents equipment vibration or cavitation caused by gas impinging on the heat-exchange tubes or heat-exchange walls of the reboiler. Thus, the present disclosure has the advantages of increasing equipment service life as well as improving operational stability and safety.

Therefore, the flue gas purification and CO2 capture coupling system according to the embodiments of the present disclosure has the advantages of enhanced operational safety and reduced capture cost.

### BRIEF DESCRIPTION OF THE DRAWINGS

FIG. 1 is a schematic view of a flue gas purification and CO₂ capture coupling system according to an embodiment of the present disclosure.

FIG. 2 is a schematic view of a flue gas purification and CO₂ capture coupling system according to another embodiment of the present disclosure.

### REFERENCE NUMERALS

boiler 1;
denitration tower 2;
air preheater 3;
a reboiler 4;
pressure-reducing valve 5;
regeneration tower 6;
pressurizing pump 7;
lean solution pump 8;
lean-rich solution heat exchanger 9;
rich solution preheater 10;
CO₂ compressor 11;
rich solution pump 12;
absorption tower 13;
pre-wash tower 14;
induced draft fan 15;
desulfurization tower 16;
dust collector 17;
flue gas reheater 18;
stack 19;
flow control valve 20;
flowmeter 21.

### DETAILED DESCRIPTION OF THE EMBODIMENTS

Embodiments of the present disclosure will be described in detail below, and examples of the embodiments are illustrated in the accompanying drawings. The embodiments described below with reference to the accompanying drawings are exemplary, intended only to explain the present disclosure, and are not to be construed as limiting the present disclosure.

The flue gas purification and CO₂ capture coupling system according to embodiments of the present disclosure will be described below with reference to the accompanying drawings, wherein the flue gas originates from a power plant boiler 1. The coupling system specifically refers to the coupling of a flue gas treatment system and a CO₂ capture system. The flue gas discharged from the boiler 1 undergoes desulfurization and denitration, after which CO₂ is captured from the flue gas by a CO₂ absorbent solution. The flue gas, after carbon capture, becomes decarbonized flue gas and is discharged to the outside. Commonly used CO₂ absorbent solutions include, but are not limited to, organic amine solutions, amino acid salt alkaline solutions, inorganic salt alkaline solutions, ionic liquids, and metal-organic framework solutions, etc.

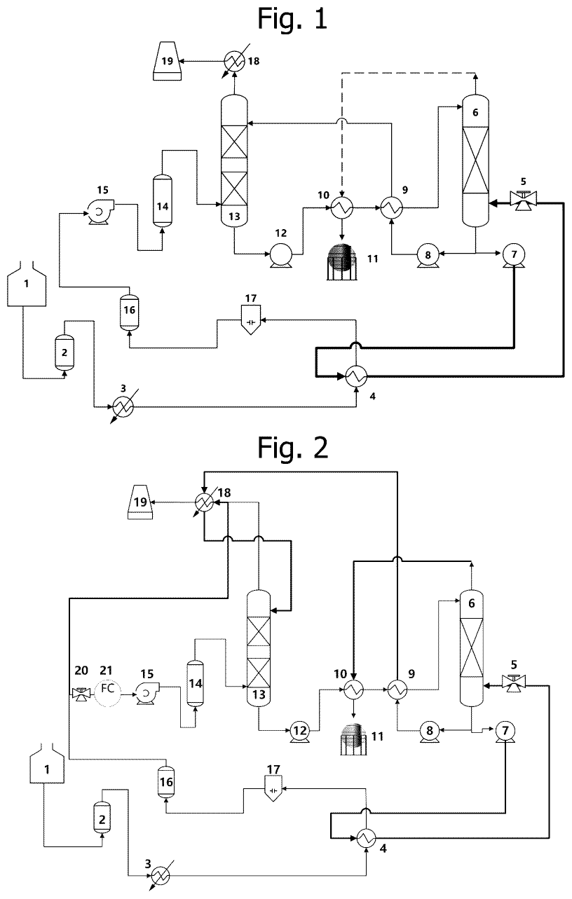

As shown in FIG. 1, in Embodiment 1, the flue gas purification and CO₂ capture coupling system according to an embodiment of the present disclosure includes: a boiler 1, a denitration tower 2, an air preheater 3, a reboiler 4, a dust collector 17, a desulfurization tower 16, a pre-wash tower 14, an absorption tower 13, a rich solution preheater 10, a lean-rich solution heat exchanger 9, a regeneration tower 6, a pressurizing pump 7, a pressure-reducing valve 5, a flue gas reheater 18, a stack 19, and a CO₂ compressor 11.

The flue gas discharged from the boiler 1 enters the denitration tower 2 for denitration. The denitrated flue gas sequentially passes through the air preheater 3 and the reboiler 4 and then enters the dust collector 17 for dust removal. After dust removal, the flue gas enters the desulfurization tower 16 for desulfurization. The desulfurized flue gas is delivered by the induced draft fan 15 to the pre-wash tower 14 for pre-washing. The pre-washed flue gas then enters the absorption tower 13, where CO₂ is captured from the flue gas by the absorbent solution (lean solution), becoming decarbonized flue gas. The absorbent solution, after capturing CO₂ in the absorption tower 13, becomes rich solution. The decarburized flue gas is discharged from the top of the absorption tower 13 and enters the flue gas reheater 18. After being reheated in the flue gas reheater 18, it is then discharged into the stack 19. The rich solution in the absorption tower 13 is discharged from the bottom of the absorption tower 13 and delivered by the rich solution pump 12. It sequentially flows through the rich solution preheater 10 and the lean-rich solution heat exchanger 9 and then enters the regeneration tower 6. In the regeneration tower 6, the rich solution is heated and desorbed for regeneration, producing a regenerated gas. After desorption and regeneration, the rich solution becomes lean solution. The regenerated gas enters the CO2 compressor 11 for compression and storage, while the lean solution is returned to the absorption tower 13 for reuse.

It should be noted that, in the existing CO₂ capture process, the regeneration energy consumption and operating cost are relatively high. The entire rich solution, after the absorbent has loaded CO2, is sent to the regeneration tower 6 for heating and regeneration. Because the proportion of water in the absorbent is high (generally more than 70%), a large amount of energy is consumed in heating and evaporating the water during the high-Temperature CO₂ desorption process (accounting for approximately 50% or more of the total energy). Therefore, changing the water environment of the regeneration process and reducing the participation of water in the regeneration process is expected to maximize the utilization of steam heat and significantly reduce regeneration energy consumption. In the conventional technology, the heat required for regeneration is usually introduced from the outside, for example, by using steam generated by a power plant steam turbine. This process, on the one hand, requires the installation of matching pipelines and other equipment, and on the other hand, consumes valuable superheated steam, thereby increasing overall energy consumption. Meanwhile, the flue gas discharged from the boiler 1 has a relatively high temperature, 350-400° C. even after passing through the denitration tower 2, and the temperature can still be maintained at 100-180° C. after passing through the air preheater. Therefore, it is suitable for providing the heat required for the desorption of the rich solution. Thus, rationally utilizing this portion of heat to obtain the heat needed for the absorbent regeneration process will be an important means to reduce the overall energy consumption of the system.

In the present embodiment, by extracting a portion of the lean solution discharged from the regeneration tower 6 and heat-exchanging it with the flue gas from the boiler 1 to form a superheated solution, thereby changing the steam environment of the regeneration process and effectively reducing the overall energy consumption of the coupling system. Herein, the superheated lean solution specifically refers to a superheated CO₂-lean solution that is maintained in a state just below boiling under a preset pressure, and the preset pressure generally refers to a pressure higher than atmospheric pressure. Optionally, the flue gas may originate from various sources that generate high-temperature flue gas, such as power plant boilers, cement plant off-gases, steel plant off-gases, and the like.

Specifically, as shown in FIG. 1, a portion of the lean solution discharged from the regeneration tower 6 enters one end of the reboiler 4, while the orthogonal other end of the reboiler 4 is connected with the boiler 1 by a pipeline, thereby allowing the portion of the lean solution to exchange heat in the reboiler 4 with the flue gas passing through the reboiler 4. After heat exchange, the temperature of the portion of the lean solution rises, thereby forming a superheated lean solution containing a mixture of liquid and vapor. This superheated lean solution is returned along the pipeline to the regeneration tower 6, where it provides the heat required for the regeneration process by releasing the steam contained in the superheated lean solution, thereby achieving efficient utilization of the flue gas waste heat. It should be noted that, in the present embodiment, the lean solution is heated by flue gas to form a superheated lean solution, and the steam in the superheated lean solution participates in the regeneration process, which can partially or even completely replace the conventional steam supplied from the steam turbine, thereby avoiding the consumption of high-value superheated steam. For example, in traditional CO2-rich solution desorption, steam extracted from the power generation unit is required to heat and desorb the rich solution in the regeneration tower. Thus, the present disclosure reduces the impact on the power generation unit and lowers the energy consumption and cost of carbon capture.

Another portion of the lean solution discharged from the regeneration tower 6 enters the lean-rich solution heat exchanger 9, so as to exchange heat with the rich solution flowing through the lean-rich solution heat exchanger 9, and the another portion of the lean solution after heat exchange enters the absorption tower 13, where it is used to capture and absorb CO₂ from the flue gas in the absorption tower 13.

On the other hand, in the embodiment of the present disclosure, the flue gas generated by the power plant boiler 1 first undergoes denitration in the denitration tower 2. The temperature of the high-temperature flue gas, which is approximately 800-1000° C. at the outlet of the boiler 1, can be reduced to approximately 350-400° C. After further cooling in the air preheater, the temperature drops to approximately 100-180° C. At this point, this portion of the flue gas still possesses a relatively high temperature and thus a relatively high available energy (exergy), which can be used to supplement the regeneration process that has the highest energy consumption, namely, the regeneration of the absorbent. Therefore, a reboiler 4 with a heat collection function is additionally provided. A portion of the lean solution produced in the regeneration tower 6 is extracted and directed to the reboiler 4, where it exchanges heat with the high-temperature flue gas after denitration to form a superheated lean solution. This superheated lean solution enters the regeneration tower 6 and becomes a two-phase vapor-liquid mixture. The vapor phase can flow upward within the regeneration tower 6, transferring the heat it carries to the packing layer to promote the desorption reaction of CO₂ from the rich solution, thereby achieving effective utilization of flue gas waste heat. The liquid phase flows to the bottom of the tower for recycling. The temperature of the flue gas passing through the reboiler 4 is approximately between 100° C. and 180° C., while the temperature of the lean solution discharged from the regeneration tower 6 is approximately between 80° C. and 140° C. A heat-exchange temperature difference of greater than 5° C. must be maintained between the two, so that heat exchange between the two in the reboiler 4 has the advantage of reducing relative heat loss.

On the other hand, it should be that, in the present embodiment, the transfer of flue-gas waste heat is accomplished by means of a portion of the lean solution extracted from the regeneration tower 6. This portion of lean solution is selected for the following reasons: on the one hand, its temperature is suitable; on the other hand, because the lean solution itself is recycled, the selection thereof can reduce the need for additional equipment required for heat exchange, thereby reducing the difficulty of modifying existing equipment and lowering the modification cost. In addition, it should be note that, related technologies in the prior art have proposed a solution in which a portion of the flue gas directly discharged from the boiler 1 passes through the reboiler 4 to heat the rich solution (45-65° C.) discharged from the regeneration tower 6, with the rich solution after heat exchange being circulated back to the regeneration tower 6. However, the inventors of the present disclosure have discovered and realized through research that, because the temperature of the flue gas from the boiler 1 is relatively high (approximately 800-1000° C.), the described prior art solution would cause severe thermal degradation of the absorbent in the rich solution. Moreover, since the rich solution is loaded with absorbed CO2, after heat exchange with the high-temperature flue gas under conventional pressure, the pipelines would be filled with desorbed CO₂ gas.

These gases would not only impinge on the pipelines causing noise and easily leading to leaks, but would also readily cause scaling inside the pipelines, resulting in blockages that affect operation and could even lead to major safety incidents. In comparison, the embodiments of the present disclosure utilize flue gas with a relatively lower temperature to exchange heat with the lean solution, thereby utilizing flue gas waste heat to provide at least a portion of the heat required for absorbent regeneration. Since the lean solution is less prone to desorb CO₂ within the pipelines, the amount of CO₂ gas in the pipelines is minimal.

Furthermore, a lean solution pump 8 capable of pressurization is provided in the pipeline at the bottom of the regeneration tower 6. The extracted portion of the lean solution is first pressurized by this lean solution pump 8 to 3-7 atmospheres. Preferably, the lean solution pump 8 pressurizes the lean solution to 3-6 atmospheres, so that after being heated in the reboiler 4, its boiling point is raised. The pressurized and heated lean solution is less prone to vaporization, thereby reducing the vapor content in this portion of the pipeline. Under the relatively high pressure, the lean solution fluid absorbs heat from the flue gas to form a superheated lean solution. This superheated lean solution carries the heat absorbed from the flue gas and can reach the desorption temperature required for the regeneration process, thereby facilitating the smooth progress of the regeneration process. Furthermore, after heat exchange, before the portion of the lean solution re-enters the regeneration tower 6, a pressure-reducing control valve is additionally provided to further depressurize the high-pressure superheated lean solution carrying heat to 1-2 atmospheres, thereby lowering its boiling point. Due to the lowered boiling point after depressurization, part of the liquid in the superheated lean solution evaporates to become hot steam, which is then returned to the regeneration tower 6 to participate in the regeneration process. Furthermore, in the portion of the lean solution that returns to the regeneration tower 6 after depressurization, the vapor phase accounts for 2%-15% of the total mass of the returned lean solution. If it exceeds 15%, excessive gas would fill the pipelines, leading to problems such as gas impinging on the pipelines; if it is below 2%, the amount of heat carried back to the regeneration tower 6 would be reduced, thereby lowering the waste heat utilization rate.

In another embodiment, the pressurizing pump 7 is arranged close to the lean solution outlet of the regeneration tower 6, and the pressure-reducing valve 5 is arranged close to the lean solution inlet of the regeneration tower 6, for example, the pressure-reducing valve 5 may be installed at the lean solution inlet of the regeneration tower 6. The lean solution inlet of the regeneration tower 6 is located below the packing inside the regeneration tower 6, for example, adjacent to the bottom surface of the packing. More preferably, the lean solution inlet is positioned above the liquid level of the lean solution at the bottom of the regeneration tower 6. This arrangement prevents the superheated lean solution returning to the regeneration tower 6 from first contacting and exchanging heat with the lean solution at the bottom of the regeneration tower 6, thereby avoiding the problem of insufficient utilization of the heat carried by this portion of the lean solution for the desorption of the rich solution, which would lead to low desorption efficiency. This further improves the desorption efficiency of the rich solution.

In another embodiment, the portion of the lean solution accounts for 20%-60% of the total mass of the lean solution discharged from the regeneration tower 6.

In another embodiment, the regenerated gas is discharged from the top of the regeneration tower 6. At this point, the temperature of the regenerated gas is above 60° C., meaning that it still carries a certain amount of heat. It is directed to the rich solution preheater 10, where it exchanges heat with the rich solution coming from the absorption tower 13. In this way, the regenerated gas is used to heat the rich solution flowing from the absorption tower 13 to the regeneration tower 6, thereby recovering the heat carried by the regenerated gas for use in absorbent regeneration. After exchanging heat with the rich solution, the regenerated gas finally enters the CO2 compressor 11 for compression and storage.

In another embodiment, the flue gas enters the reboiler 4 after denitration but before dust removal, that is, the utilization of flue gas waste heat occurs between the denitration and dust removal stages. This is because the dust collector 17 has relatively greater difficulty in handling high-temperature flue gas, which needs to be cooled to 90° C. Since the temperature of the flue gas after denitration can still be as high as 180° C., arranging the reboiler 4 between the denitration tower 2 and the dust collector 17 to utilize the flue gas waste heat is relatively more reasonable.

In another embodiment, the decarbonized flue gas discharged from the absorption tower 13 is heated in the flue gas reheater 18, and then enters the stack 19 for discharge, thereby raising the exhaust temperature of the stack 19 (generally increasing the exhaust temperature to above 80° C.), and reducing the “white plume” phenomenon from the stack 19.

In the flue gas purification and CO₂ capture coupling system according to the embodiments of the present disclosure, the efficiency of cyclic utilization of heat within the system, such as flue gas waste heat and the heat carried by regenerated gas and lean solution, is improved, steam consumption is substantially reduced, and the CO₂ capture cost can be reduced by 40%-50%. At the same time, the adoption of the present system reduces the impact on the power generation unit caused by steam extraction and eliminates the need for additional equipment such as steam temperature reduction and pressure reduction devices. Furthermore, the heat exchange mode used in the present system overcomes the problems commonly encountered in related technologies, such as gas impingement on pipelines, pipeline leakage, impact vibration, and cavitation, thereby improving the operational performance and safety of the system.

Another specific embodiment of the flue gas purification and CO2 capture coupling system of the present disclosure will be described below with reference to FIG. 2.

Compared with the embodiment shown in FIG. 1, the flue gas purification and CO₂ capture coupling system according to this further embodiment of the present disclosure, as shown in FIG. 2, additionally includes a flow control valve 20. The flow control valve 20 is configured to control the ratio of the flue gas entering the flue gas reheater 18 and the flue gas entering the absorption tower 13 from the desulfurization tower 16, thereby enabling control of the flow rate of the flue gas entering the CO₂ capture device. In addition, a portion of the lean solution discharged from the regeneration tower 6, after exchanging heat with the rich solution discharged from the absorption tower 13 in the lean-rich solution heat exchanger 9, does not return directly to the absorption tower 13. Instead, it enters the flue gas reheater 18 to exchange heat with the decarbonized flue gas before returning to the absorption tower 13, thereby further utilizing the heat from this portion of the lean solution to supplement the temperature of the discharged flue gas.

In the flue gas purification and CO₂ capture coupling system according to the embodiments of the present disclosure, the flow control valve 20 enables control of both the amount of flue gas flowing from the desulfurization tower 16 into the pre-wash tower 14 and the absorption tower 13 and the amount of flue gas flowing from the desulfurization tower 16 into the flue gas reheater 18. Therefore, the flue gas amount entering the absorption tower 13 for carbon capture can be flexibly adjusted according to the carbon capture load capacity of the coupling system. For example, it is possible to achieve carbon capture operation that completely eliminates the need to consume high-value superheated steam, i.e., completely eliminating the need to extract steam from the power generation unit, further reducing the energy consumption and cost of carbon capture, avoiding any impact on the power generation unit, lowering the difficulty and cost of modifying existing power generation units, and improving the overall coupling performance of flue gas purification and CO₂ capture. on

the other hand, in the event of a fault in the carbon capture process, the flue gas can be entirely directed to the flue gas reheater 18 and then discharged through the stack 19, without affecting the emission of the purified flue gas or the operation of the power generation unit.

In addition, a portion of the lean solution discharged from the regeneration tower 6, passes through the lean-rich solution heat exchanger 9, and then enters the flue gas reheater 18 to exchange heat with the decarbonized flue gas. This utilizes the heat contained in this portion of the lean solution to heat the decarbonized flue gas, thereby reducing the amount of heat that needs to be supplied to the flue gas reheater 18 from other heat sources, further lowering energy consumption, and reducing the “white plume” phenomenon in the emissions from the stack 19. Furthermore, by controlling a portion of the desulfurized flue gas to enter the flue gas reheater 18 by the flow control valve 20, the temperature of the decarbonized flue gas can be further increased, thereby more effectively preventing the “white plume” phenomenon in the emissions from the stack 19.

For example, as shown in FIG. 2, the flue gas purification and CO₂ capture coupling system according to the embodiments of the present disclosure further includes a flowmeter 21 matched with the flow control valve, so as to monitor the flow rate of the flue gas entering the CO₂ capture device. The flowmeter 21 is arranged between the flow control valve and the induced draft fan 15. Furthermore, the flow control valve 20 may also be a three-way valve, with the inlet of the three-way valve connected to the desulfurized flue gas outlet of the desulfurization tower 16. One outlet of the three-way valve is connected to the induced draft fan 15, which is used to supply desulfurized flue gas to the pre-wash tower 14, while the other outlet of the three-way valve is connected to the flue gas inlet of the flue gas reheater 18. The decarbonized flue gas outlet of the absorption tower 13 is also connected to the flue gas inlet of the flue gas reheater 18. The flowmeter 21 is arranged between the flow control valve and the induced draft fan 15. The induced draft fan 15 can extract the flue gas from the outlet of the desulfurization tower 16 into the pre-wash tower 14.

Optionally, in some other embodiments, the flow control valve 20 may also include two separately arranged control valves. For example, one control valve is arranged between the desulfurized flue gas outlet of the desulfurization tower 16 and the flue gas inlet of the flue gas reheater 18 to control the amount of desulfurized flue gas discharged from the desulfurization tower 16 that enters the flue gas reheater 18, while the other control valve is arranged between the desulfurized flue gas outlet of the desulfurization tower 16 and the induced draft fan 15 to control the amount of flue gas entering the pre-wash tower 14 from the desulfurization tower 16. Of course, the two control valves need to be operated in coordination.

The embodiment of the present disclosure shown in FIG. 2 may be identical to the embodiment shown in FIG. 1 in all other aspects, which will not be repeated here.

The flue gas purification and CO2 capture coupling method according to the embodiments of the present disclosure will be described below in conjunction with embodiment 1.

The flue gas purification and CO₂ capture coupling method according to embodiments of the present disclosure includes:
The flue gas discharged from the flue gas generation device is purified by the flue gas purification device and then enters the CO₂ capture device. After CO₂ capture and decarbonization, the flue gas is finally discharged to the outside, while completing CO₂ storage. The CO₂ capture device includes an absorption tower 13 and a regeneration tower 6, wherein the rich solution that has captured CO₂ in the absorption tower 13 flows into the regeneration tower 6, where it is heated and desorbed in to a regenerated gas and a lean solution; the regenerated gas and the lean solution are separately discharged from the regeneration tower 6;
A portion of the lean solution discharged from the regeneration tower 6 exchanges heat with flue gas that has been discharged from the flue gas generation device but has not yet entered the CO2 capture device, thereby forming a superheated lean solution. The superheated lean solution is returned to the regeneration tower to provide steam and heat for desorption.

In the flue gas purification and CO₂ capture coupling method according to the embodiments of the present disclosure, a portion of the lean solution discharged from the regeneration tower 6 is directed to the reboiler 4 to exchange heat with the flue gas passing through the reboiler 4. After heat exchange, the portion of the lean solution is returned to the regeneration tower 6. In this way, flue gas waste heat is utilized to heat this portion of the lean solution in the reboiler 4, thereby using flue gas waste heat for absorbent regeneration.

This can partially or even completely replace conventional steam heating, thereby avoiding the consumption of high-value superheated steam, for example, steam extracted from a power generation unit. As a result, the impact on the power generation unit is reduced, and the energy consumption and cost of carbon capture are lowered.

Furthermore, compared to the related technologies that use the rich solution in the regeneration tower 6 to exchange heat with flue gas in order to utilize flue gas waste heat, the embodiments of the present disclosure utilize a lean solution having a relatively lower temperature and lower CO₂ content to exchange heat with the flue gas, thereby utilizing flue gas waste heat to provide at least a portion of the heat required for absorbent regeneration. Since the lean solution is less prone to vaporization within the pipelines, resulting in a minimal amount of gas in the pipelines, it does not cause gas impingement on the pipelines or walls, thereby reducing the risk of leakage, lowering vibration, minimizing cavitation, providing good operational performance and high safety, and thus overcoming the defects in the related technologies caused by using the rich solution for heat exchange with flue gas. Moreover, the temperature of the lean solution discharged from the regeneration tower 6 is close to the temperature of the flue gas passing through the reboiler 4, resulting in a relatively small temperature difference between the two. Therefore, the heat exchange between them in the reboiler 4 has the advantage of reducing relative heat loss.

A specific embodiment of the flue gas purification and CO₂ capture coupling method according to the present disclosure is described below. The method includes: the flue gas discharged from the boiler 1 sequentially passes through the denitration tower 2, the air preheater 3, the reboiler 4, the dust collector 17, the desulfurization tower 16, and the pre-Wash tower 14, and then enters the absorption tower 13; in the absorption tower 13, CO₂ is captured from the flue gas using an absorbent solution; the flue gas becomes decarbonized flue gas, which is discharged from the top of the absorption tower 13 and enters the flue gas reheater 18, and then flows from the flue gas reheater 18 to the stack 19 for emission.

The absorbent solution, after capturing CO₂ in the absorption tower 13, becomes rich solution. The rich solution enters the rich solution preheater 10, then flows from the rich solution preheater 10 to the lean-rich solution heat exchanger 9, and then enters the regeneration tower 6 for desorption and regeneration, producing regenerated gas. The absorbent solution thereby becomes lean solution.

The regenerated gas is discharged from the top of the regeneration tower 6 and enters the rich solution preheater 10 to exchange heat with the rich solution coming from the absorption tower 13. The regenerated gas after heat exchange is compressed and stored.

A portion of the lean solution in the regeneration tower 6 is discharged from the bottom of the regeneration tower 6 and enters the lean-rich solution heat exchanger 9, where it exchanges heat with the rich solution coming from the rich solution preheater 10, and then enters the absorption tower 13 for CO₂ absorption and capture. A portion of the lean solution discharged from the bottom of the regeneration tower 6 is pressurized and enters the reboiler 4, where it exchanges heat with the denitrated flue gas passing through the reboiler 4 to form a superheated lean solution. After depressurization, the superheated lean solution is returned to below the packing in the regeneration tower 6. The vapor phase therein flows upward through the packing, providing steam and heat for the desorption of the rich solution in the regeneration tower 6.

The flue gas purification and CO₂ capture coupling method of the present disclosure utilizes a portion of the lean solution discharged from the regeneration tower 6 to exchange heat with the flue gas after denitration before returning it to the regeneration tower 6, thereby utilizing flue gas waste heat for absorbent desorption and regeneration. Moreover, by exchanging heat between the regenerated gas and the rich solution discharged from the absorption tower 13, the heat carried by the regenerated gas is further utilized, thereby improving the cyclic utilization of heat within the system. This can partially or even completely replace conventional steam heating, thereby avoiding consumption of high-value superheated steam, and significantly reducing the CO₂ capture cost.

Furthermore, utilizing the lean solution for heat exchange with the flue gas, as compared to the related technologies in which the rich solution in the regeneration tower 6 is used for heat exchange with the flue gas, has the following advantages: the lean solution is less prone to vaporization and desorption of absorbed CO2 within the pipelines, resulting in a minimal amount of gas in the pipelines. This prevents gas from impinging on the pipelines or walls, reduces the risk of pipeline leakage, lowers vibration caused by impacts, minimizes cavitation, and provides good operational performance and high safety. Moreover, the lean solution discharged from the regeneration tower 6 is first pressurized, then exchanges heat with the flue gas, and is finally depressurized before returning it to the regeneration tower 6. This process can more effectively reduce the vaporization of the lean solution or the desorption of CO₂ within the pipelines, as well as the resulting problems of impingement, vibration, cavitation, and the like. At the same time, it can better utilize the flue gas waste heat carried by the lean solution after heat exchange with the flue gas.

The decarbonized flue gas passes through the flue gas reheater 18 before entering the stack 19 for emission, thereby reducing the “white plume” phenomenon from the stack 19.

Another specific embodiment of the flue gas purification and CO₂ capture coupling method according to the present disclosure is described below.

Compared with the foregoing embodiments, in this further specific embodiment, a portion of the lean solution discharged from the regeneration tower 6, after exchanging heat with the rich solution in the lean/rich solution heat exchanger 9, is directed to the flue gas reheater 18 to exchange heat with the decarbonized flue gas before being returned to the absorption tower 13, rather than being returned directly to the absorption tower 13. This arrangement enables better utilization of the heat carried by this portion of the lean solution, improves the overall cyclic utilization of heat within the system, more effectively eliminates the “white plume” phenomenon from the stack 19, and reduces the amount of heat that needs to be supplied to the flue gas reheater 18 from other heat sources. On the other hand, controlling the ratio of desulfurized flue gas entering the absorption tower 13 and the flue gas reheater 18 allows for flexible adjustment of the amount of flue gas entering the absorption tower 13 for carbon capture according to the carbon capture load capacity of the coupling system. For example, it is possible to achieve carbon capture operation that completely eliminates the need to consume high-value superheated steam, i.e., completely eliminating the requirement to extract steam from the power generation unit, thereby further reducing the energy consumption and cost of carbon capture, avoiding any impact on the power generation unit, lowering the difficulty and cost of modifying existing power generation units, and improving the overall coupling performance of flue gas purification and carbon capture. On the other hand, in the event of a fault in the carbon capture process, the flue gas can be entirely directed to the flue gas reheater 18 and then discharged through the stack 19, without affecting the emission of the purified flue gas or the operation of the power generation unit.

The flue gas purification and CO₂ capture coupling method according to this further embodiment of the present disclosure may be identical to the flue gas purification and CO2 capture coupling method of the foregoing embodiments in all other aspects, which will not be repeated here.

In the description of the present disclosure, it should be understood that the orientation or position relations indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. are based on the orientation or position relations shown in the drawings. These terms are used for the convenience of describing the disclosure and simplifying the description, and do not indicate or imply that the device or component in question must have a specific orientation, be constructed in a particular orientation, or operate in a specific direction. Therefore, these terms should not be interpreted as limitations on the disclosure.

In addition, the terms “first” and “second” are used herein for purposes of description and are not intended to indicate or imply relative importance or significance or to imply the number of indicated technical features. Thus, the features defined by “first” and “second” may explicitly or implicitly include at least one of the features. In the description of the present disclosure, the meaning of “a plurality of” is at least two, for example, two, three, etc., unless specified otherwise.

In the present disclosure, unless specified or limited otherwise, the terms “mounted,” “connected,” “connected,” “fixed” and the like are used broadly, and may be, for example, fixed connections, detachable connections, or integral connections; may be a mechanical connection, and may also be an electrical connection or communication with each other; may be a direct connection, and may also be an indirect connection via an intermediate medium; and may be inner communication of two elements or an interaction relationship between two elements, unless clearly defined otherwise. The specific meanings of the described terms in the present disclosure can be understood by those skilled in the art according to specific situations.

In the present disclosure, unless specified or limited otherwise, a structure in which a first feature is “on” or “under” a second feature may include an embodiment in which the first feature is in direct contact with the second feature, and may also include an embodiment in which the first feature and the second feature are in indirect contact via an intermediary. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. The first feature “below,” “under,” or “on bottom of” the second feature may include an embodiment in which the first feature is right or obliquely “below,” “under,” or “on bottom of” the second feature, or just means that the first feature is at a height lower than that of the second feature.

In this disclosure, the terms “one embodiment,” “some embodiments,” “an example,” “a specific example,” or “some examples,” etc., mean that a particular feature, structure, material, or characteristic described in connection with the embodiment or example is included in at least one embodiment or example of the present disclosure. Thus, the appearances of the phrases in various places throughout this description are not necessarily referring to the same embodiment or example of the present disclosure. Furthermore, the particular features, structures, materials, or characteristics described may be combined in any suitable manner in one or more embodiments or examples. In addition, those skilled in the art can combine and integrate the different embodiments or examples and the features of the different embodiments or examples described in the description without conflicting with each other.

Although the embodiments have been shown and described, it would be appreciated by those skilled in the art that the embodiments above cannot be construed to limit the present disclosure, and changes, alternatives, and modifications can be made in the embodiments without departing from spirit, principles and scope of the present disclosure.

1. A flue gas purification and CO₂ capture coupling system, comprising a flue gas generation device, a flue gas purification device, and a CO₂ capture device, wherein flue gas discharged from the flue gas generation device enters the CO₂ capture device after being purified by the flue gas purification device; after CO₂ capture and decarbonization, the flue gas is finally discharged to an outside, while simultaneously completing separation and storage of CO₂. the CO₂ capture device comprises an absorption tower and a regeneration tower; a rich solution that has absorbed CO₂ in the absorption tower flows into the regeneration tower, where the rich solution is heated and desorbed into a regenerated gas and a lean solution; the regenerated gas and the lean solution are separately discharged from the regeneration tower; wherein a portion of the lean solution discharged from a bottom of the regeneration tower exchanges heat with flue gas that has been discharged from the flue gas generation device but has not yet entered the CO₂ capture device, thereby forming a superheated lean solution; the superheated lean solution is then returned to the regeneration tower to provide steam and heat for the desorption;
the regeneration tower is provided with a lean solution inlet and a lean solution outlet located at the bottom of the regeneration tower; the lean solution inlet is located below packing inside the regeneration tower and above a liquid level of a lean solution pool at the bottom of the regeneration tower; the CO₂ capture device comprises a reboiler, a pressurizing pump, and a pressure-reducing valve; the pressurizing pump is arranged between the regeneration tower and the reboiler and close to the lean solution outlet of the regeneration tower; the pressure-reducing valve is arranged between the reboiler and the regeneration tower and close to the lean solution inlet of the regeneration tower; flue gas generated by the flue gas generation device passes through the reboiler and exchanges heat with the portion of the lean solution; the pressurizing pump is used to pressurize the portion of the lean solution to raise a boiling point of the portion of the lean solution, and the pressure-reducing valve is used to depressurize the superheated lean solution after the superheated lean solution has passed through the reboiler and exchanged heat with the flue gas, thereby lowering the boiling point of the superheated lean solution; a depressurized superheated lean solution then returns to the regeneration tower through the lean solution inlet and releases steam.

2. The flue gas purification and CO₂ capture coupling system according to claim 1, wherein the flue gas generation device comprises a boiler and an air preheater, and flue gas discharged from the boiler passes through the air preheater and then exchanges heat with the portion of the lean solution.

3. The flue gas purification and CO₂ capture coupling system according to claim 2, wherein the CO₂ capture device further comprises a lean-rich solution heat exchanger, wherein the rich solution discharged from the absorption tower passes through the lean-rich solution heat exchanger and then enters the regeneration tower, and another portion of lean solution discharged from the regeneration tower enters the lean-rich solution heat exchanger to exchange heat with the rich solution flowing through the lean-rich solution heat exchanger and then enters the absorption tower;
and/or the flue gas purification device comprises a denitration tower and a desulfurization tower, flue gas discharged from the boiler passes through the denitration tower, the air preheater, and the desulfurization tower, and then enters the absorption tower; after CO₂ capture and decarbonization, the flue gas becomes decarbonized flue gas and is discharged from the absorption tower to the outside.

4. The flue gas purification and CO₂ capture coupling system according to claim 3, wherein the pressurizing pump pressurizes the portion of the lean solution discharged from the regeneration tower to 3-7 atmospheres;
and/or, the pressure-reducing valve depressurizes the superheated lean solution discharged from the reboiler to 1.2-2.0 atmospheres;
and/or in a portion of the lean solution returned to the regeneration tower after depressurization, a vapor phase accounts for 2%-15% of a total mass of a returned lean solution;
and/or the portion of the lean solution accounts for 20%-60% of a total mass of the lean solution discharged from the regeneration tower.

5. The flue gas purification and CO₂ capture coupling system according to claim 3, wherein the CO₂ capture device further comprises a rich solution preheater, a rich solution generated in the absorption tower sequentially passes through the rich solution preheater and the lean-rich solution heat exchanger and then enters the regeneration tower, and a regenerated gas generated in the regeneration tower enters the rich solution preheater to exchange heat with the rich solution passing through the rich solution preheater;
and/or the CO₂ capture device further comprises a flue gas reheater, the another portion of the lean solution discharged from the regeneration tower sequentially passes through the lean-rich solution heat exchanger and the flue gas reheater and then enters the absorption tower, and the decarburized flue gas discharged from the absorption tower enters the flue gas reheater to exchange heat with the lean solution passing through the flue gas reheater and then is discharged to the outside.

6. The flue gas purification and CO₂ capture coupling system according to claim 5, wherein the CO₂ capture device further comprises a flow control valve, the flow control valve is used to control a ratio between flue gas entering the flue gas reheater and flue gas entering the absorption tower from the desulfurization tower; and/or a flowmeter matched to the flow control valve is further provided.

7. The flue gas purification and CO₂ capture coupling system according to claim 5, wherein
the flue gas purification device further comprises a pre-wash tower, a dust collector, and a stack, and the CO₂ capture device further comprises a CO₂ compressor, wherein the dust collector is arranged between the reboiler and the desulfurization tower and is used to remove dust from flue gas discharged from the reboiler, and the CO₂ compressor is connected with the rich solution preheater to compress the regenerated gas after the regenerated gas has exchanged heat with the rich solution in the rich solution preheater;
and/or the flue gas purification device further comprises two flow control valves and an induced draft fan; the induced draft fan is arranged between a desulfurized flue gas outlet of the desulfurization tower and the pre-wash tower; one of the two flow control valves is arranged between a desulfurized flue gas outlet of the desulfurization tower and a flue gas inlet of the flue gas reheater, to control an amount of desulfurized flue gas entering the flue gas reheater from the desulfurization tower, while the other of the two flow control valves is arranged between the desulfurized flue gas outlet of the desulfurization tower and the induced draft fan, to control an amount of flue gas entering the pre-wash tower from the desulfurization tower; the two flow control valves are operated in coordination.

8. A flue gas purification and CO₂ capture coupling method, using the flue gas purification and CO₂ capture coupling system according to claim 1, the flue gas purification and CO₂ capture coupling method comprising:
flue gas discharged from a flue gas generation device is purified by a flue gas purification device and then enters a CO₂ capture device; after CO₂ capture and decarburization, the flus gas is finally discharged to an outside, while completing storage of CO₂; the CO₂ capture device comprises an absorption tower and a regeneration tower; a rich solution that has absorbed CO₂ in the absorption tower flows into the regeneration tower, where the rich solution is heated and desorbed into a regenerated gas and a lean solution; the regenerated gas and lean solution are separately discharged from the regeneration tower;
a portion of the lean solution discharged from a bottom of the regeneration tower exchanges heat with flue gas that has been discharged from the flue gas generation device but has not yet entered the CO₂ capture device, thereby forming a superheated lean solution; the superheated lean solution is returned to the regeneration tower to provide steam and heat for desorption; flue gas that has been discharged from the flue gas generation device but has not yet entered the CO₂ capture device passes through a reboiler of the CO₂ capture device and exchange heat with the portion of the lean solution;
the portion of the lean solution discharged from the regeneration tower is pressurized to raise a boiling point of the portion of the lean solution, and a pressurized portion of lean solution exchanges heat with flue gas that has been discharged from the flue gas generation device but has not yet entered the CO₂ capture device; and
the superheated lean solution is depressurized to lower a boiling point of the superheated lean solution, and a depressurized superheated lean solution is returned to below packing in the regeneration tower.

9. The flue gas purification and CO₂ capture coupling method according to claim 8, wherein the portion of the lean solution discharged from the regeneration tower is pressurized to raise the boiling point of the portion of the lean solution, and the pressurized portion of the lean solution exchanges heat with flue gas that has been discharged from the flue gas generation device but has not yet entered the CO₂ capture device; the superheated lean solution is depressurized to lower the boiling point of the superheated lean solution, and the depressurized superheated lean solution is returned to the regeneration tower.

10. The flue gas purification and CO₂ capture coupling method according to claim 9, wherein the rich solution discharged from the absorption tower sequentially exchanges heat with the regenerated gas discharged from the regeneration tower and another portion of lean solution discharged from the regeneration tower, and then flows into the regeneration tower.

11. The flue gas purification and CO₂ capture coupling method according to claim 10, further comprising causing the flue gas discharged from the flue gas generation device to sequentially undergo denitration, air preheating, heat exchange with the portion of the lean solution discharged from the regeneration tower, dust removal, and desulfurization; a portion of desulfurized flue gas and another portion of lean solution that has been discharged from the regeneration tower and has exchanged heat with the rich solution exchanges heat with the decarbonized flue gas discharged from the absorption tower; the another portion of lean solution that has exchanged heat with the decarbonized flue gas flows into the absorption tower; decarbonized flue gas that has exchanged heat with the portion of desulfurized flue gas and the another portion of lean solution is discharged to the outside; another portion of desulfurized flue gas enters the absorption tower.

12. The flue gas purification and CO₂ capture coupling method according to claim 11, further comprising controlling a ratio of the portion of desulfurized flue gas that exchanges heat with the decarbonized flue gas to the another portion of desulfurized flue gas that enters the absorption tower.

13. The flue gas purification and CO₂ capture coupling system according to claim 4, wherein the CO₂ capture device further comprises a rich solution preheater, a rich solution generated in the absorption tower sequentially passes through the rich solution preheater and the lean-rich solution heat exchanger and then enters the regeneration tower, and a regenerated gas generated in the regeneration tower enters the rich solution preheater to exchange heat with the rich solution passing through the rich solution preheater;
and/or the CO₂ capture device further comprises a flue gas reheater, the another portion of the lean solution discharged from the regeneration tower sequentially passes through the lean-rich solution heat exchanger and the flue gas reheater and then enters the absorption tower, and the decarburized flue gas discharged from the absorption tower enters the flue gas reheater to exchange heat with the lean solution passing through the flue gas reheater and then is discharged to the outside.

14. The flue gas purification and CO₂ capture coupling method according to claim 8, wherein the flue gas generation device comprises a boiler and an air preheater, and flue gas discharged from the boiler passes through the air preheater and then exchanges heat with the portion of the lean solution.

15. The flue gas purification and CO₂ capture coupling method according to claim 14, wherein the CO₂ capture device further comprises a lean-rich solution heat exchanger, wherein the rich solution discharged from the absorption tower passes through the lean-rich solution heat exchanger and then enters the regeneration tower, and another portion of lean solution discharged from the regeneration tower enters the lean-rich solution heat exchanger to exchange heat with the rich solution flowing through the lean-rich solution heat exchanger and then enters the absorption tower;
and/or the flue gas purification device comprises a denitration tower and a desulfurization tower, flue gas discharged from the boiler passes through the denitration tower, the air preheater, and the desulfurization tower, and then enters the absorption tower; after CO₂ capture and decarbonization, the flue gas becomes decarbonized flue gas and is discharged from the absorption tower to the outside.

16. The flue gas purification and CO₂ capture coupling method according to claim 15, wherein the pressurizing pump pressurizes the portion of the lean solution discharged from the regeneration tower to 3-7 atmospheres;
and/or, the pressure-reducing valve depressurizes the superheated lean solution discharged from the reboiler to 1.2-2.0 atmospheres;
and/or in a portion of the lean solution returned to the regeneration tower after depressurization, a vapor phase accounts for 2%-15% of a total mass of a returned lean solution;
and/or the portion of the lean solution accounts for 20%-60% of a total mass of the lean solution discharged from the regeneration tower.

17. The flue gas purification and CO₂ capture coupling method according to claim 15, wherein the CO₂ capture device further comprises a rich solution preheater, a rich solution generated in the absorption tower sequentially passes through the rich solution preheater and the lean-rich solution heat exchanger and then enters the regeneration tower, and a regenerated gas generated in the regeneration tower enters the rich solution preheater to exchange heat with the rich solution passing through the rich solution preheater;
and/or the CO₂ capture device further comprises a flue gas reheater, the another portion of the lean solution discharged from the regeneration tower sequentially passes through the lean-rich solution heat exchanger and the flue gas reheater and then enters the absorption tower, and the decarburized flue gas discharged from the absorption tower enters the flue gas reheater to exchange heat with the lean solution passing through the flue gas reheater and then is discharged to the outside.

18. The flue gas purification and CO₂ capture coupling method according to claim 17, wherein the CO₂ capture device further comprises a flow control valve, the flow control valve is used to control a ratio between flue gas entering the flue gas reheater and flue gas entering the absorption tower from the desulfurization tower; and/or a flowmeter matched to the flow control valve is further provided.

19. The flue gas purification and CO₂ capture coupling method according to claim 17, wherein
the flue gas purification device further comprises a pre-wash tower, a dust collector, and a stack, and the CO₂ capture device further comprises a CO₂ compressor, wherein the dust collector is arranged between the reboiler and the desulfurization tower and is used to remove dust from flue gas discharged from the reboiler, and the CO₂ compressor is connected with the rich solution preheater to compress the regenerated gas after the regenerated gas has exchanged heat with the rich solution in the rich solution preheater;
and/or the flue gas purification device further comprises two flow control valves and an induced draft fan; the induced draft fan is arranged between a desulfurized flue gas outlet of the desulfurization tower and the pre-wash tower; one of the two flow control valves is arranged between a desulfurized flue gas outlet of the desulfurization tower and a flue gas inlet of the flue gas reheater, to control an amount of desulfurized flue gas entering the flue gas reheater from the desulfurization tower, while the other of the two flow control valves is arranged between the desulfurized flue gas outlet of the desulfurization tower and the induced draft fan, to control an amount of flue gas entering the pre-wash tower from the desulfurization tower; the two flow control valves are operated in coordination.
